(19) United States
(12) Patent Application Publication
(10) Pub. No.: US 2025/0064177 A1
(43) Pub. Date: Feb. 27, 2025

(54) BUCKLE CLASP WITH REMOVABLE CAPSULE

(71) Applicant: LVMH SWISS MANUFACTURES SA, LA CHAUX DE FONDS (CH)

(72) Inventor: Laurent TATON, Wanchai (CN)

(73) Assignee: LVMH SWISS MANUFACTURES SA, LA CHAUX DE FONDS (CH)

(21) Appl. No.: 18/704,776

(22) PCT Filed: Oct. 21, 2022
(86) PCT No.: PCT/EP2022/079476

§ 371 Date: Nov. 4, 2024

(30) Foreign Application Priority Data
Oct. 27, 2021 (FR) FR2111390

(51) Int. Cl. A44B 11/00; A63B 57/30

(52) U.S. Cl. CPC A44B 11/005; A63B 57/353; A44D 2203/00; A63B 2209/08

(57) ABSTRACT

The present invention relates to a buckle clasp system (1) for a bracelet, the buckle clasp system (1) further comprising a golf ball marker (60), the second part (12) having a cover (50) having an upper part (51) having a thickness and a lower part (52), the cover (50) comprising, arranged in the thickness of the upper part (51), a housing, the housing having a flat bottom corresponding to the lower part (52) of the cover (50), the housing being configured to house the golf ball marker (60), the golf ball marker (60) having a shape corresponding to the housing, the system further comprising clamping means, the clamping means providing magnetic and/or mechanical clamping, configured to hold the golf ball marker (60) in the housing.

### TECHNICAL FIELD

The present invention relates to the field of bracelet clasps, more specifically buckle clasps, for example the folding buckle type, especially for watchbands. The buckle bracelet clasps according to the invention can be used for mechanical, quartz or connected watches.

### BACKGROUND

The present invention targets a clasp for bracelet, in particular a bracelet such as a watchband, the bracelet having two strands attached to the clasp, which is of the buckle type.

As is known, a buckle clasp allows a user to thread a bracelet around the wrist in the open position of the clasp, then close the buckle around the wrist so that the wrist is sufficiently fastened in the attached position of the clasp. Such a clasp may be of the folding buckle type. In this case, the clasp has at least two parts mounted in a pivot with respect to one another. The two parts of the folding buckle clasp are attached to the bracelet to form a closed bracelet. To move the clasp into the attached position, a first part of the clasp is held in the continuity of the bracelet, e.g. by leaning against the user's wrist, while the second part of the clasp pivots until it meets the first part of the clasp. The second part is fastened to the first by means of additional means of restraint. In this way, the bracelet is attached to the user's wrist. Release means, for example in the form of push buttons on either side of the buckle, enable the clasp to be returned to the open position.

In the case of a watch, the bracelet has two strands attached at one end to the watch case and at the other end to one of the two parts of the clasp.

In addition, as is known, many golfers wear a watch, such as a smartwatch, while practicing their sport. In a round of golf, it is necessary to mark the position of the ball after making a stroke, so that the ball can be placed in exactly the same position in the next stroke.

For this purpose, players use a golf ball marker. The issue discussed here relates in particular to the function of a golf ball marker. For golfers, there is a constraint to carrying such a golf ball marker.

As a solution, the present invention proposes a buckle clasp system that incorporates such a golf ball marker, housed in a housing arranged in the clasp, with the ball marker being removable, advantageously easy to grasp and replace in the housing. More generally, the buckle clasp according to the invention allows a removable capsule, in particular a golf ball marker, to be carried, which the user can extract and reinsert into the housing, in a recess provided in the clasp.

In the clasp according to the invention, the characteristics related to the integration of the removable capsule, in particular the golf ball marker, are advantageously independent of the closure means of the clasp itself.

### SUMMARY

Specifically, the invention is directed to a watch comprising a bracelet having two strands and a buckle clasp system, the buckle clasp system comprising a first part adapted to be attached to the first strand and having means of restraint, and a second part having means of additional fastening of the means of restraint, to fasten the second part to the first part of the buckle clasp system, allowing the bracelet to be attached to a user's wrist, the buckle clasp system further comprising a removable capsule, in particular a removable golf ball marker, adapted to mark the position of a golf ball on a golf course, the second part having a cover having an upper part having a thickness and a lower part, the cover comprising, fitted in the thickness of the upper part, a housing, the housing having a flat bottom corresponding to the lower part of the cover, the housing being configured to house the removable golf ball marker, the removable golf ball marker having a shape corresponding to the housing, the buckle clasp system further comprising clamping means, the clamping means ensuring magnetic and/or mechanical clamping, configured to hold the removable golf ball marker in the housing.

The location of the golf ball marker housing in the cover of the buckle clasp and the magnetic and/or mechanical clamping means are suitable for integration of the golf ball marker into a buckle clasp of a bracelet designed to conform to a user's wrist curvature and for normal use to frequently extract and reinsert the golf ball marker from the housing.

The golf ball marker is suitable for marking the position of a golf ball on a golf course.

According to an embodiment, the clamping means comprise guide rails arranged longitudinally in the mass of the lower part of the cover, to guide the golf ball marker in translation, in a direction corresponding to a longitudinal axis of the bottom of the housing, so that, in a first translation direction, guide the golf ball marker into the housing and, in a second translation direction opposite the first, to allow extraction of the golf ball marker so that the user can grasp it.

In particular, the guide rails can be carved into the mass of the lower part of the cover, on two side faces and opposite the housing, the rails being parallel to the longitudinal axis of the bottom of the housing, and the golf ball marker has matching grooves suitable for sliding in the rails.

According to another embodiment, the clamping means comprise two grooves and two corresponding lugs, the lugs having a mushroom shape, the two grooves being arranged on two parallel side faces of the cover, and the two lugs being provided on two parallel faces of the golf ball marker, or, vice versa, the two grooves being arranged on two parallel side faces of the golf ball marker, and the two lugs being provided on two parallel faces of the cover.

According to an embodiment, the clamping means provide magnetic clamping of the golf ball marker in the housing and comprise at least one magnet arranged at the bottom of the housing.

In particular, the at least one magnet is embedded in resin, especially an epoxy resin, so that it does not corrode over time. The attraction force of at least one magnet is, in particular in this case, between 240 g and 320 g.

In particular, the at least one magnet may be offset with respect to a median transverse axis of the bottom of the housing.

According to another embodiment, the at least one magnet is aligned on a median transverse axis of the bottom of the housing.

Depending on an embodiment, means of restraint, among a ball or a protrusion, are

provided at the bottom of the housing and cooperate with additional means of restraint provided on a lower face of the golf ball marker.

In particular, the housing is shaped like a profiled rectangular parallelepiped.

According to an embodiment, the buckle is of the unfolding buckle type, the second

part of the buckle being mounted pivoting on the first part.

In particular, the second part of the buckle clasp system comprises a passage for the first strand, at least one head and means of releasing the second part with respect to the first part.

The present invention also relates to a watch comprising a bracelet having two strands and a buckle clasp system as briefly described above.

According to an embodiment, one of the strands of the bracelet, upstream of the housing, comprises a deflection rib adapted to deflect the golf ball marker when it is extracted.

According to an embodiment, the watch includes computational electronic means and memory space, as well as means of connecting to a digital data network.

### BRIEF DESCRIPTION OF THE DRAWINGS

The invention will be better understood upon reading the following description, given solely as an example, and by referring to the accompanying figures, given as non-limiting examples, wherein identical references are given to similar objects and wherein:

FIG. 1 shows a first embodiment of a buckle clasp according to the invention, in the case of a folding buckle clasp;

FIG. 2A shows a diagram of the housing arranged in the cover, according to the first embodiment;

FIG. 2B shows a diagram of the golf ball marker, according to the first embodiment;

FIG. 3 shows a second embodiment of a buckle clasp according to the invention, in the case of another folding buckle clasp;

FIG. 4 shows a third embodiment of a buckle clasp according to the invention, in the case of another folding buckle clasp;

FIG. 5 shows a fourth embodiment of a buckle clasp according to the invention, in the case of another folding buckle clasp;

FIG. 6 shows a fifth embodiment of a buckle clasp according to the invention, in the case of another folding buckle clasp.

It should be noted that the figures disclose the invention in detail in order to implement the invention, said figures can of course be used to better define the invention where applicable. As stated previously, the embodiments shown are not limiting. In particular, in the embodiments shown, the buckle of the clasp according to the invention is of the folding buckle type. However, the invention can also be implemented in a buckle clasp of the prong type.

### DETAILED DESCRIPTION

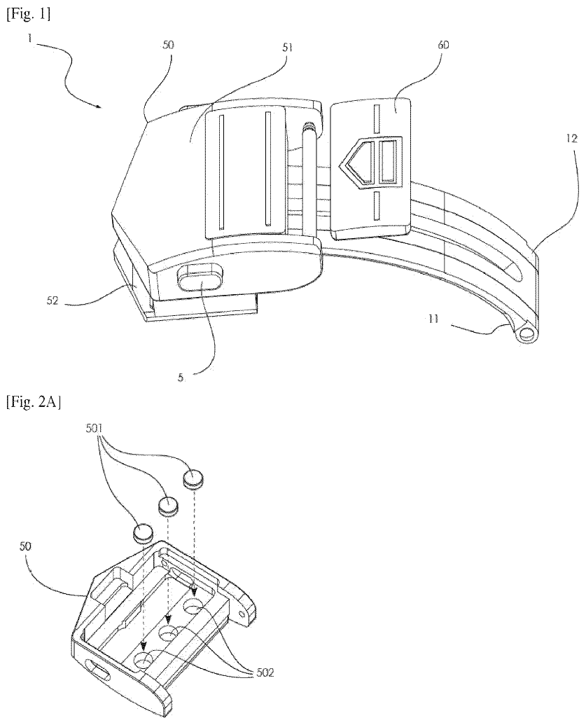

As shown in FIG. 1, the invention relates to a buckle clasp 1, which may be of the folding buckle type, or alternatively of the prong type, for a bracelet, including a watchband, for example a smartwatch strap, the clasp comprising a detachable capsule housed in a housing arranged in the buckle clasp 1. In particular, the removable capsule is a golf ball marker 60.

An advantage of the invention is that a golf ball marker 60, which is particularly suitable for performing the function of a golf ball marker, can be integrated into a buckle clasp. Another advantage of the invention is that this integration is realized in an esthetic way and with a high level of perceived quality for the user. In particular, the golf ball marker 60 is of a size suitable for this purpose, i.e. it is visible to the user in the vicinity, when placed on the ground on a golf course.

More precisely, with reference to the figures, the present invention proposes a buckle clasp 1 in which a housing 530, for example a cavity, is arranged to house a golf ball marker 60.

The buckle clasp 1 further comprises a cover 50 which contains at least part of the means of restraint and release of the at least two parts of the clasp. In the cover 50 of buckle 1, a housing 530 is created to house the golf ball marker 60. More specifically, the housing 530 is fitted in an upper part 51 of the cover 50. For example, the housing 530 is a cavity carved in the thickness of the upper part 51 of the cover 50. Housing 530 has a shape corresponding to the shape of the golf ball marker 60. Preferably, the housing 530 substantially has a rectangular parallelepiped shape. According to an embodiment, the rectangular parallelepiped shape is called “profiled”, i.e. the housing 530 has a bottom 531 having a curvature, particularly corresponding to the curvature of the clasp, in the continuity of the bracelet as attached to the user's wrist.

A lower part 52 of the cover 50 includes means to hold the golf ball marker 60 in the housing 530.

More specifically, to hold the golf ball marker 60 in the housing 530, means of clamping are used. These means of clamping can be used for magnetic and/or mechanical clamping.

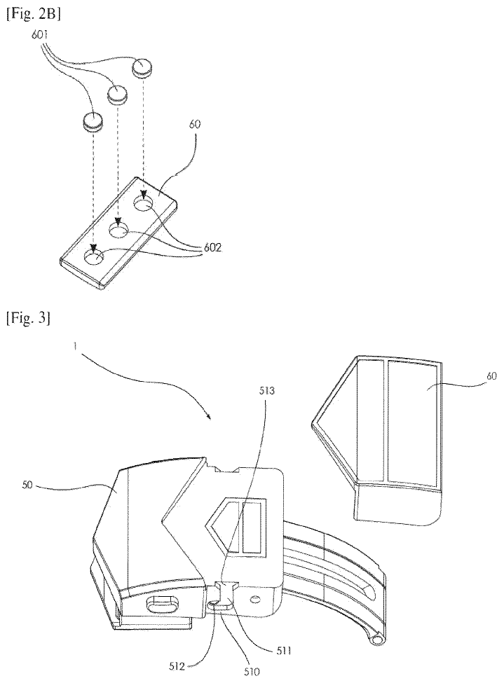

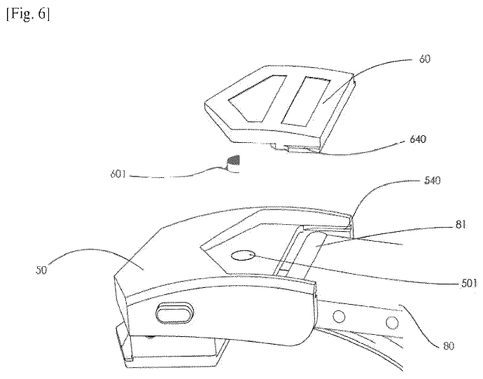

In reference to FIGS. 2A, 2B and 6, the said means of clamping provide magnetic clamping and consist mainly of a magnet or preferably several magnets 501, 601, arranged on the bottom 531 of the housing 530 and/or on a lower face of the golf ball marker 60. This embodiment is described in detail hereinafter. According to an embodiment, said magnets 501 are integrated in the bottom 531 of the housing 530.

Preferably, magnets 501, 601 are aligned on a median transverse axis of housing

530. Here, the term “median transverse axis” is understood to mean an axis orthogonal to a main longitudinal direction of the clasp in the continuity of the bracelet, and dividing the bottom 531 of the housing 530 into two parts of substantially equal surfaces.

However, magnets 501, 601 may also be offset from this median transverse axis.

According to the invention, the magnet(s) 501, 601 are configured to generate on the golf ball marker 60 a magnetic attraction force adapted to ensure it is held in the housing 530, including when the user is wearing the watch while playing golf. To this end, the magnetic attraction force generated by the magnets 501, 601 when the golf ball marker 60 is fully housed in the housing 530 is notably between 1.0 N and 3.0 N, in particular between 1.5 N and 2.0 N.

According to an embodiment, the magnets 501, 601 are encapsulated, i.e. embedded, in an epoxy resin, so that they do not corrode over time.

In addition, according to an embodiment, the magnets 501, 601 are configured, in their position aligned with the median transverse axis at the bottom 531 of the housing 530, and in the magnetic attraction force they induce, so as to ensure that the golf ball marker 60 is held in the housing 530 in near-unstable equilibrium. In other words, a force having a longitudinal component, i.e. orthogonal to the median transverse axis, or even tangential to the clasp in the bracelet continuity, of a small modulus, i.e. a modulus only greater than or equal to an extraction threshold that can typically present a value of 1.0 N, is sufficient to extract the golf ball marker 60 from an area in which the magnetic attraction force generated by the magnets 501, 601 is mainly exerted. Therefore, as soon as the user applies a force greater than the extraction threshold of 1.0 N, the golf ball marker 60 easily translates out of the housing 530.

Preferably, before the 530 housing, a deflection rib can be provided on the bracelet. As soon as the golf ball marker 60 in motion outwards from the housing 530 hits the said deflection rib, the deflection rib deflects the trajectory of the golf ball marker 60, acting as a deflector, so that the golf ball marker 60 is lifted and becomes easy to grasp between two fingers.

Various other embodiments are described hereinafter, in connection with the figures.

As a general rule, the buckle clasp 1 according to the invention may be of the folding buckle type. In this case, on its first part 11, for example, the unfolding buckle comprises a bar with a passage for a first strand 80 passing through the passage and is held by a bead of the first strand 80, preventing the translation of the first strand 80 in the opposite direction, and/or by a mechanical clamping between the first part 11 of the unfolding buckle and the first strand 80. The second part 12 of the folding buckle comprises, for example, a rod suitable for passing through a throughput tube of the second strand and for being held by its two ends in corresponding cavities of the second part 12 of the folding buckle. The second part 12 can be folded over the first part 11 to tighten the bracelet around the user's wrist, the first and second parts 11, 12 being attached to each other by means of locking means, for example heads engaging in corresponding holes, coupled with release means 5. In any event, the manner in which the folding buckle is attached to the bracelet and the way in which it locks and unlocks to move from a closed to an open position and vice versa are not part of the present invention and the person skilled in the art is free to use, in these aspects, any known technology.

In any case, the buckle of the buckle clasp 1 according to the invention comprises a cover 50. In particular, the cover 50 can be configured to house and mask, for esthetic purposes, the means of locking and releasing the buckle. According to the invention, the housing 530 specially configured to house the golf ball marker 60 is arranged in the mass of the cover 50; for example, the housing 530 is a cavity carved into the thickness of the upper part 51 of the cover 50.

According to the invention, a housing 530 is thus created in the upper part 51 of the cover 50, for example a cavity carved in the mass of the upper part 51 of the cover 50 or planned during the manufacture of the cover 50 by stamping. The housing 530 has a profiled rectangular parallelepiped shape, preferably with a flat bottom 531, i.e. two-dimensional only, without asperity and with reduced roughness. Proper flatness and roughness contribute separately and together to the adhesion of the golf ball marker 60 in the housing 530, maximizing the contact surface, which is particularly effective with the magnetic clamping mode described in detail hereinafter.

The golf ball marker 60 is configured to present a volume corresponding to that of the housing 530, in particular complementary to the housing 530 created in the cover 50. According to an embodiment, a pattern is provided on top of the golf ball marker 60, forming an overthickness, in order to improve grip and thus facilitate the grip or translation of the golf ball marker 60 for its extraction.

The upper part 51 of the cover 50 can be designed to be pivoted so that the contents of the housing 530 are accessible. Alternatively, the upper part 51 of the cover 50 can be shifted. In this case, the direction of translation of the lid is opposite to the direction in which the golf ball marker 60 is moved out of the housing 530.

According to an embodiment, as shown in FIG. 6, upstream of housing 530, on the bracelet strand fastened to the clasp upstream of the cover 50, a deflection rib 81 is planned. The deflection rib 81 acts as a “deflector”: i.e. when the golf ball marker 60 is pressed with your thumb to extract it from the housing 530, in particular by initiating a translation outwards from the housing 530 in order to grasp it, a sliding of the golf ball marker outwards from the housing 530 is initiated by translating it along a longitudinal axis of the bottom 531 of the housing 530, along the buckle, in the direction of the deflection rib 81; the deflection rib 81 deflects and lifts the golf ball marker in translation, making it easier to grip.

Magnetic clamping of golf ball marker in the housing:

According to an embodiment, as shown in FIGS. 2A, 2B and 6, a magnetic clamping of the golf ball marker 60 in the housing 530 is provided. Magnetic clamping uses at least one 501, 601 magnet, including a plurality of magnets 501, 601, in particular three or six magnets. In particular, magnets 501 can only be provided on the cavity side; the golf ball marker 60 is then made of a corresponding material, i.e. capable of cooperating with the magnets so that a magnetic force of attraction is created between the magnets and the golf ball marker 60. For example, the golf ball marker 60 is made of steel or titanium.

The magnets 501 provided on the cavity side in the housing 530 can be encapsulated in an epoxy resin. The attraction force exerted by magnets 501 on the golf ball marker is then between 240 g and 320 g, for example.

According to an embodiment, magnets 601 are provided on a bottom face of the golf ball marker 60, either in place of or in addition to those previously described as provided for in bottom 531 of housing 530. The magnets 601 on the lower face of the golf ball marker 60 can also be encapsulated in an epoxy resin.

As shown in FIGS. 2A, 2B, magnet(s) 501, 601 may be housed in corresponding recesses 502, 602, provided at the bottom 531 of the housing 530 and/or, if applicable, on a bottom face of golf ball marker 60. The magnet(s) can also be glued.

Magnetization is configured so that a magnetic attraction force, holding the golf ball marker 60 in the housing 530, is adapted to prevent the golf ball marker 60 from moving out of the housing 530 independently, including when the bracelet including the watch comprising the bracelet with the buckle clasp 1 according to the invention is worn. This applies in particular to the fact that the user is playing golf.

“Suitable magnetic attraction force” means a magnetic attraction force whose modulus is between 1.0 N and 3.0 N when the golf ball marker 60 is in the plumb line of the magnet(s) 501 on the housing side 530, depending on the embodiment, and in contact with the bottom 531 of the housing 530 or at a distance from the bottom 531 of the housing 530 of less than 0.2 mm. Thus, the magnetic attraction force is such that the golf ball marker 60 is held in the housing 530 and the force required to dislodge the golf ball marker 60 from the housing 530, by user action, is adapted accordingly. In particular, the force to be applied to the golf ball marker 60 in an extraction direction, in translation along an axis parallel to a longitudinal axis of the bottom 531 of the housing 530, is only a modulus greater than 1.0 N.

With reference to FIG. 2A and FIG. 2B, a plurality of magnets 501, 601, in this case three magnets, are fixed to the bottom 531 of the housing 530. According to an embodiment, the magnets are “invisible” from the outside because they are located below the surface of the bottom 531 of the housing 530.

To this end, magnets 501 are arranged or fixed to the bottom 531 of the housing 530, in particular in hollow recesses provided for at the bottom 531 of the housing 530, and then covered with a small plate of a material such as the material making up the cover 50, or at least having a color identical to or similar to that of the material of the cover 50. For example, the plate covering magnets 501 is made of titanium. In particular, buckle clasp 1 as a whole is for example made of the same material. For example, the plate thickness is between 0.6 mm and 1.3 mm.

Alternatively, depending on an embodiment, the magnet(s) 502 may be arranged on the golf ball marker 60. The function is the same as for the case where the magnet(s) are only arranged at the bottom 531 of the housing 530.

According to another embodiment, corresponding to the embodiment shown in FIG. 2A, FIG. 2B and FIG. 6, additional magnets 501, 601 are arranged both at the bottom 531 of the housing 530 and on the golf ball marker 60. In this case, the additional shapes of the housing 530 and the golf ball marker 60 can be configured to ensure a foolproofing function. This means that housing 530 and golf ball marker 60 thus have a shape such that there is only one way of inserting golf ball marker 60 into housing 530, so that the complementary magnets 501, 601 cooperate in order to generate a magnetic force of attraction, not repulsion.

According to the preferred embodiment shown in FIGS. 2A and 2B, three magnets 501 are arranged at the bottom 531 of the housing 530 and three magnets 502 are arranged on a lower face of the golf ball marker 60. Three magnets 501 are aligned on an axis corresponding substantially to a median transverse axis of the bottom 531 of the housing 530. Correspondingly, three magnets 502 are arranged in a substantially aligned manner on a median transverse axis of the golf ball marker 60. Magnets 501, 601, on the housing side 530 or removable capsule 60 side can for example be replaced by metal elements cooperating with magnets 501, 601 placed on the golf ball marker 60 or at the bottom 531 of housing 530, respectively.

In the embodiment of FIG. 1, the upper part 51 of the hood 50 pivots to cover or on the contrary to allow access to the housing 530, as already briefly described previously.

According to an alternative embodiment not shown, the magnets may be eccentric, i.e. offset with respect to the median transverse axis of the bottom 531 of the housing 530. The magnets are then aligned with each other but offset in a direction corresponding to the longitudinal axis of the bottom 531 of housing 530, inwards from housing 530, i.e. in an opposite direction to the extraction direction corresponding to the direction in which the golf ball marker 60 is translated to extract it from the housing 530. In particular, the magnets can then be offset by approximately 1.5 mm from the median transverse axis. The same applies, where applicable, to the magnets on the removable capsule 60 side.

In all embodiments implementing a magnetic clamping of the golf ball marker 60 in the housing 530, preferably the arrangement of the magnets 501, 601 and the magnetic attraction force generated are configured so that, as soon as a pulling force is exerted in one extraction direction of the golf ball marker 60, an imbalance of forces is created and the magnetic clamping force that held the removable capsule 60 in the housing 530 presents a modulus that falls rapidly with the separating of the golf ball marker 60 from the alignment axis of the magnets 501, 601, making it easy to move and thus extract the ball marker.

It should be noted that, according to the invention, a plurality of magnets, in particular three non-aligned magnets, may be provided for magnetic clamping of the golf ball marker 60 in the housing 530, whether at the bottom 531 of the housing 530 and/or on a lower face of the golf ball marker 60. This results in the capsule being held the same or similar, or even greater, in the sense that the resulting magnetic attraction force would have, compared to the case where the magnets are aligned, an identical modulus, but the magnetic attraction force would be more distributed over the entire contact surface between the golf ball marker 60 and the bottom 531 of the housing 530. The resulting disadvantage is the counterpart of this more even distribution and therefore better stability: the force required to extract the golf ball marker 60 would be greater.

In the preferred embodiment, wherein one or two sets of three aligned magnets are used, in particular aligned with the median transverse axis of the bottom 531 of the housing 530, instability is created from the first millimeters away from the golf ball marker 60 with respect to the axis of alignment of the magnets. This also applies when magnets are provided on both the bottom 531 of the 530 housing and on the golf ball marker 60.

In the embodiment where magnets 501 are provided on the housing 530 side and on the removable capsule 60 side, a polarity reversal exists between the magnets on the housing 530 side and the magnets on the removable capsule 60 side. In this case, the respective complementary shapes of the golf ball marker 60 and housing 530 can be used as a foolproofing function. Alternatively, for the same purpose, an alternating polarity of the magnets on the housing 530 side and the removable capsule 60 side may be provided accordingly.

According to an embodiment, however, for practical reasons, the golf ball marker 60 has a shape that allows it to be inserted in either direction. In this case, in particular, magnet(s) 501 are placed only at the bottom 531 of housing 530, preferably under the surface of bottom 531 of housing 530, and golf ball marker 60 has material complementary to the magnet(s).

Mechanical clamping pf the golf ball marker in the housing:

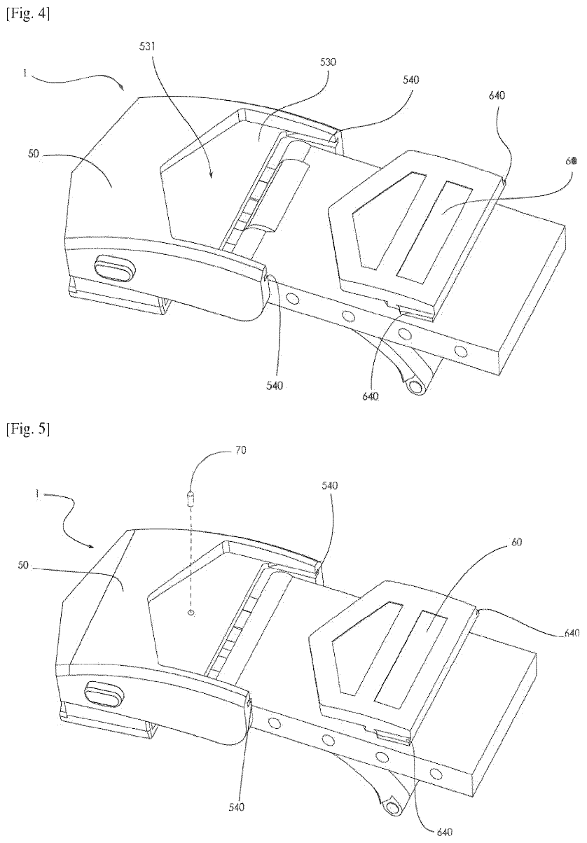

In reference to FIG. 3, the clamping of the golf ball marker 60 in the housing 530 can also be mechanical. According to this embodiment, grooves are carved in the mass of the second part 12 of the buckle clasp 1, more specifically in the lower part 52 of the cover 50, on two outer and parallel sides, the grooves being for example on a promontory provided in the housing 530 and carved at the bottom of an upper surface of the promontory, configured to be in contact with the lower face of the golf ball marker 60. Correspondingly, lugs, such as substantially cylindrical protrusions, are provided on two internal faces opposite each other on the golf ball marker 60. The lugs are inserted into the grooves to guide and hold the golf ball marker 60 in the housing 530. Conversely, the lugs are guided into the grooves until the golf ball marker 60 is pulled out when the user grasps the golf ball marker 60.

In particular, the grooves open to the outside for the removal of the golf ball marker 60.

More particularly, in reference to FIG. 3, grooves 510 have advantageously at least two sections 511, 512 extending in main directions forming an angle between them, in particular between 30° and 150°. For each groove 510, a first section 511 ends on the outside, opposite the mass of the housing 530, allowing the lugs to be inserted or removed. For each groove 510, a second section 512 forms an angle with the first section 511, in particular between 30° and 150°,preferably greater than 90°, for example equal to 120°, the angle being rounded, to facilitate the sliding of the lugs in the respective grooves 510 from or to a final position in which the golf ball marker 60 is housed and held in the housing 530.

According to an embodiment, the end portion 513 of the first section 511, which ends on the outside, can be widened to facilitate the insertion of the lugs into the grooves 510.

An embodiment implementing an alternative mechanical clamping is shown in FIG. 4. Rails 540 are provided on the side walls of the housing 530 and grooves 640 provided on the side faces of the golf ball marker 60 are configured to engage in the rails 540 to guide the golf ball marker 60 from or to the final position where the golf ball marker 60 is housed and held in the housing 530.

As shown in FIG. 5, in addition to the previous embodiment, a ball or a protrusion 70, particularly in the central position, providing a holding function of the golf ball marker 60 in translation may also be provided, in particular by cooperating with a concavity provided on the mower face of the golf ball marker 60, to prevent the golf ball marker 60 from independently pulling out of the housing 530.

Magnetic and mechanical clamping of the golf ball marker in the housing:

In reference to FIG. 6, the clamping of the golf ball marker 60 in the housing 530 can be both mechanical and magnetic. In particular, means of guidance, such as rails 540, provide partial mechanical clamping while at least one magnet, provided on the bottom 531 of the housing 530 and/or on the golf ball marker 60, also provides magnetic clamping.

The at least one magnet can thus be placed in a recess 502, 602 corresponding to the bottom 531 of the housing 530 and/or on a bottom side of the golf ball marker 60. In particular, several magnets 501, 601 may be provided on the bottom 531 of the housing 530, aligned or not, and/or on the golf ball marker 60.

1-15. (canceled)

16. A watch comprising a bracelet having two strands and a buckle clasp system, the buckle clasp system comprising a first part adapted to be attached to the first strand and having means of restraint, and a second part having means of attachment complementary to the means of restraint, for fixing the second part to the first part of the buckle clasp system, allowing to attach the bracelet to a user's wrist, the buckle clasp system further comprising a removable golf ball marker, adapted to mark the position of a golf ball on a golf course, the second part having a cover having an upper part having a thickness and a lower part, the cover comprising, arranged in the thickness of the upper part, a housing, the housing having a flat bottom corresponding to the lower part of the cover, the housing being configured to house the removable golf ball marker, the removable golf ball marker having a shape corresponding to the housing, the buckle clasp system also comprising clamping means, the clamping means ensuring magnetic and/or mechanical clamping, configured to hold the removable golf ball marker in the housing.

17. The watch according to claim 16, wherein the clamping means comprise longitudinally arranged guide rails in the mass of the lower part of the cover, to guide the removable golf ball marker in translation, in a direction corresponding to a longitudinal axis of the bottom of the housing, so that, in a first translation direction, guide the removable golf ball marker into the housing and, in a second translation direction opposite to the first, allow extraction of the removable golf ball marker so that the user can grasp it.

18. The watch according to claim 17, wherein the guide rails are carved into the mass of the lower part of the cover, on two side faces and opposite the housing, the rails being parallel to the longitudinal axis of the bottom of the housing, and the removable golf ball marker comprises matching grooves able to slide in the rails.

19. The watch according to claim 16, wherein the clamping means comprise two grooves and two corresponding lugs, the lugs having a mushroom shape, the two grooves being arranged on two parallel side faces of the cover, and the two lugs being provided on two parallel faces of the removable golf ball marker, or, vice versa, the two grooves being arranged on two parallel side faces of the golf ball marker, and the two lugs being provided on two parallel faces of the cover.

20. The watch according to claim 16, wherein the clamping means provide magnetic clamping of the removable golf ball marker in the housing and comprise at least one magnet arranged at the bottom of the housing.

21. The watch according to claim 20, wherein the at least one magnet is offset from a median transverse axis of the bottom of the housing.

22. The watch according to claim 20, wherein the at least one magnet is aligned to a median transverse axis of the bottom of the housing.

23. The watch according to claim 20, wherein the at least one magnet is embedded in resin.

24. The watch according to claim 20, wherein the at least one magnet has an attraction force comprised between 240 g and 320 g.

25. The watch according to claim 16, comprising means of restraint, among a ball or a protrusion, provided at the bottom of the housing and cooperating with additional means of restraint provided on a lower face of the removable golf ball marker.

26. The watch according to claim 16, wherein the housing has a profiled rectangular parallelepiped shape.

27. The watch according to claim 16, wherein the buckle is of the unfolding buckle type, the second part of the buckle being mounted pivoting on the first part.

28. The watch according to claim 27, wherein the second part of the buckle clasp system comprises a passage for the first strand, at least one head and means of releasing the second part with respect to the first part.

29. The watch according to claim 16, one of the strands of the bracelet, upstream of the housing, comprising a deflection rib adapted to deflect the removable golf ball marker when extracting it.

30. The watch according to claim 16, the watch comprising computational electronic means and memory space, as well as means of connecting to a digital data network.
